(19) United States
(12) Patent Application Publication
(10) Pub. No.: US 2018/0279032 A1
(43) Pub. Date: Sep. 27, 2018

(54) Smart Windshield for Utilization with Wireless Earpieces

(71) Applicant: BRAGI GmbH, München (DE)

(72) Inventor: Peter Vincent Boesen, München (DE)

(73) Assignee: BRAGI GmbH, München (DE)

(21) Appl. No.: 15/914,075

(22) Filed: Mar. 7, 2018

Related U.S. Application Data
(60) Provisional application No. 62/474,999, filed on Mar. 22, 2017.

(51) Int. Cl. H04R 1/10; B60J 1/02; G06F 21/32

(52) U.S. Cl. CPC H04R 1/1016; H04R 1/1091; B60J 1/02; G06F 3/167; H04R 2420/07; H04R 2499/13; G06F 21/32

(57) ABSTRACT

A smart windshield system in embodiments of the present invention may have one or more of the following features: (a) a smart windshield operably capable of displaying data to a user, (b) an Internet of Things (IoT) network operably coupled to the smart windshield and a constrained intelligent edge real time embedded device (CIERTED), (c) a wireless earpiece operably coupled to the IoT and the smart windshield, wherein the wireless earpiece can control the CIERTED and the data displayed on the smart windshield.

### PRIORITY STATEMENT

This application claims priority to U.S. Provisional Patent Application No. 62/474,999 filed on Mar. 22, 2017 titled Smart Windshield for Utilization with Wireless Earpieces, all of which is hereby incorporated by reference in its entirety.

### FIELD OF THE INVENTION

The present invention relates to vehicles. Particularly, the present invention relates to wearable electronic devices. More particularly, but not exclusively, the illustrative embodiments relate to a smart windshield vehicle which integrates with or communicates with wireless earpieces.

### BACKGROUND

Vehicles may come with various types of electronics packages. These packages may be standard or optional and may often represent the types of communications or entertainment options available. However, there are various problems and deficiencies with such offerings.

The next frontier in Internet of Things (IoT) may be the vehicle windshield. Automakers, technology companies and glass manufacturers are currently developing displays like a smart phone for the windshield of a car. One showing directions and vehicle information to the person behind the wheel.

The advent of connected cars and using a vehicle's windshield may be the next way to provide more information to the driver and/or passenger. Data-driven services in autos are expected to generate billions of dollars in revenue by 2030. At least part will be spent projecting information to drivers and passengers.

What is needed are vehicles with improved electronics options which create, improve, or enhance the safety and overall experience of the vehicles.

### SUMMARY

Therefore, it is a primary object, feature, or advantage of the illustrative embodiment to improve over the state of the art.

A method for utilizing a smart windshield with one or more wireless earpieces in embodiments of the present invention may have one or more of the following steps: (a) associating the one or more wireless earpieces with the smart windshield, (b) receiving data from a user wearing the one or more wireless earpieces, (c) communicating the data from the one or more wireless earpieces to the smart windshield of the vehicle, (d) verifying the user is authorized to utilize the smart windshield, (e) measuring biometrics of the user utilizing the one or more wireless earpieces, (f) controlling vehicle systems associated with the smart windshield utilizing user input in the data, and (g) adjusting volume controls of the vehicle in response to the data.

A wireless earpiece in embodiments of the present invention may have one or more of the following features: (a) a housing for fitting in an ear of a user, (b) a processor controlling functionality of the wireless earpiece, (c) a plurality of sensors performing sensor measurements of the user and an environment of the user, and (d) one or more transceivers managing communications between the wireless earpiece and a smart windshield wherein the processor associates the one or more wireless earpieces with the smart windshield, receives data from a user wearing the one or more wireless earpieces, and communicates the data from the one or more wireless earpieces to the smart windshield of the vehicle.

A smart windshield system in embodiments of the present invention may have one or more of the following features: (a) a smart windshield operably capable of displaying data to a user, (b) an Internet of Things (IoT) network operably coupled to the smart windshield and a constrained intelligent edge real time embedded device (CIERTED), (c) a wireless earpiece operably coupled to the IoT and the smart windshield, wherein the wireless earpiece can control the CIERTED and the data displayed on the smart windshield.

One or more of these and/or other objects, features, or advantages of the illustrative embodiments will become apparent from the specification and claims following. No single embodiment need provide every object, feature, or advantage. Different embodiments may have different objects, features, or advantages. Therefore, the illustrative embodiments are not to be limited to or by any object, feature, or advantage stated herein.

### BRIEF DESCRIPTION OF THE DRAWINGS

Illustrated embodiments of the disclosure are described in detail below with reference to the attached drawing figures, which are incorporated by reference herein.

FIG. 1 is a pictorial representation of a vehicle system 1 in accordance with an illustrative embodiment;

FIG. 2 is a pictorial representation of wireless earpieces in accordance with illustrative embodiments;

FIG. 3 is a block diagram illustrating a wireless earpiece, such as the left wireless earpiece or the right wireless earpiece of FIG. 2 in accordance with an illustrative embodiment;

FIG. 4 is a flowchart of a process for communications between one or more wireless earpieces and a smart windshield of a vehicle in accordance with an illustrative embodiment;

FIG. 5 is a flowchart of a process for communications between one or more wireless earpieces and a smart windshield in accordance with an illustrative embodiment;

FIG. 6 depicts a computing system in accordance with an illustrative embodiment; and

FIG. 7 illustrates embedded devices within an IoT network in an illustrative embodiment.

### DETAILED DESCRIPTION

The following discussion is presented to enable a person skilled in the art to make and use the present teachings. Various modifications to the illustrated embodiments will be clear to those skilled in the art, and the generic principles herein may be applied to other embodiments and applications without departing from the present teachings. Thus, the present teachings are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of vehicle smart windshield applications, it is fully contemplated embodiments of the present invention could be used in most any smart windshield application without departing from the spirit of the invention.

It is an object, feature, or advantage of the illustrative embodiments to communicate between vehicle systems including a smart windshield and wearable earpieces.

One embodiment provides a system and method for utilizing a smart windshield with one or more wireless earpieces. The one or more wireless earpieces are associated with the smart windshield. Data is received from a user wearing the one or more wireless earpieces. The data is communicated from the one or more wireless earpieces to the smart windshield of the vehicle.

Another embodiment provides a wireless earpiece. The wireless earpiece includes a housing for fitting in an ear of a user. The wireless earpiece also includes a processor controlling functionality of the wireless earpiece. The wireless earpiece also includes several sensors performing sensor measurements of the user. The wireless earpiece also includes one or more transceivers managing communications between the wireless earpieces and a smart windshield. The processor associates the one or more wireless earpieces with the smart windshield, receives data from a user wearing the one or more wireless earpieces, and communicates the data from the one or more wireless earpieces to the smart windshield of the vehicle.

The illustrative embodiments provide a system, method, and wireless earpieces for communicating with a smart windshield. In one embodiment, the wearable devices represent one or more wireless earpieces worn in ears of the user. The user may represent a driver, passenger, administrator, or other party within a vehicle. The vehicle may represent a car, truck, bus, train, plane, motorcycle, boat, or other transportation vehicle or vessel. Data, information, content, or biometrics may be automatically or manually pushed/pulled between the wireless earpieces and the smart windshield.

The wireless earpieces may include any number of sensors utilized to receive user input, feedback, commands, and so forth. For example, the sensors may include microphones, accelerometers, gyroscopes, touch sensors, optical sensors, and other sensing components. The wireless earpieces may sense data about the user, the user's environment, driving conditions, or so forth. The data gathered by the wireless earpieces may be communicated to the smart windshield for display to a user in an informative way without being distracting. For example, the user's vitals, such as heart rate, temperature, and blood pressure may be displayed to the smart windshield. The biometrics may be displayed in accordance with user preferences set for the wireless earpieces. The user preferences may specify any number of thresholds, parameters, selections, information, or data controlling the communications and other interactions between the one or more wireless earpieces and the smart windshield.

The data measured or captured by the wireless earpieces may include user input, feedback, instructions, or commands. In one embodiment, the data received by the smart windshield from the one or more wireless earpieces may be utilized to control or otherwise manage one or more systems, subsystems, or processes of the smart windshield. The user input may include voice commands, head motions, tactile input (e.g., taps, swipes, etc.), gestures, or another sensed user input. For example, head nods performed by a user wearing the one or more wireless earpieces may be utilized to increase or decrease the volume based on the direction of the nod (e.g., vertical nods increase the volume while horizontal nods decrease the volume). In another example, a tap on the right wireless earpiece may skip a track in the music or movie being played to the user or passengers of the vehicle. In another example, the user may select to display information relating to vehicle performance in English units or metric units utilizing a verbal command (e.g., display speed in kilometers per hour).

One or more wireless earpieces may communicate with the smart windshield. In one embodiment, the wireless earpieces may represent a set of wireless earpieces including a left wireless earpiece and a right wireless earpiece utilized by a single user. In other embodiments, the wireless earpieces may represent several individual or sets of wireless earpieces being utilized by multiple users (e.g., co-drivers, copilots, passengers, administrators, safety officers, etc.).

The one or more wireless earpieces may communicate with the smart windshield utilizing one or more wireless signals, connections, links, standards, or protocols. In one embodiment, the wireless earpieces may be paired with the smart windshield and communicate utilizing Bluetooth (e.g., Bluetooth low energy, Bluetooth 5.0, Bluetooth 6.0, etc.). In one embodiment, the wireless earpieces may verify or authenticate the user is authorized to utilize the wireless earpieces with the smart windshield. For example, a password, pin, input sequence, or other input may be required to access the systems of the vehicle including the smart windshield through the wireless earpieces.

The illustrative embodiments enhance the features and functionality of the wireless earpieces as well as the smart windshield of the vehicle and other vehicle systems. As a result, users can simply and safely implement any number of processes otherwise distracting to the driver, passengers, or other occupants of the vehicle. Therefore, it is expected the illustrative embodiments will make any vehicle so equipped more desirable to customers, more satisfying to customers, and potentially more profitable for the vehicle manufacturer. Similarly, at least some of the various aspects may be added to existing vehicles as after-market accessories to improve the safety or experience of existing vehicles.

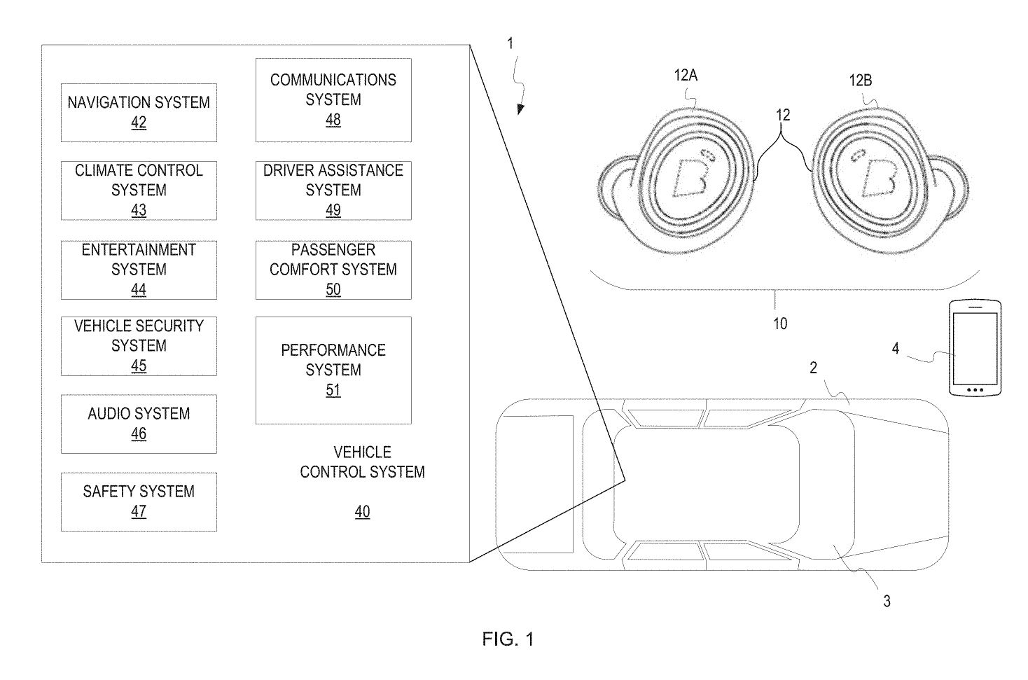

FIG. 1 is a pictorial representation of a vehicle system 1 in accordance with an illustrative embodiment. Although a vehicle 2 is shown as a car in FIG. 1, the vehicle may be representative of any number of types of cars, trucks, sport utility vehicles, vans, mini-vans, automotive vehicles, commercial vehicles, agricultural vehicles, construction vehicles, specialty vehicles, recreational vehicles, buses, motorcycles, aircraft, boats, ships, yachts, trains, spacecraft, or other types of vehicles. The vehicle 2 may be gas-powered, diesel-powered, electric, solar-powered, or human-powered. The vehicle 2 may be actively operated by a driver or may be partially or completely autonomous or self-driving. The vehicle 2 may have a vehicle control system 40. The vehicle control system 40 is a system which may include any number of mechanical and electromechanical subsystems. As shown in FIG. 1, such systems may include a navigation system 42, a climate control system 43, an entertainment system 44, a vehicle security system 45, an audio system 46, a safety system 47, a communications system 48, a driver assistance system 49, a passenger comfort system 50, and a performance system 51 (e.g., engine, transmission, chassis electronics system).

The vehicle 2 further includes a smart windshield 3. The smart windshield 3 is shown as the front window of the vehicle 2, but may represent any number of windows, mirrors, or other surfaces of the vehicle 2. In one embodiment, reference to the smart windshield 3 may also include reference to the vehicle control system 40 integrated with the vehicle 3.

Other types of vehicle control systems may be employed by the vehicle 2 as well. In the automotive context, examples of the safety system 47 may include active safety systems such as air bags, hill descent control, lane departure warnings, and an emergency brake assist system. Furthermore, in the automotive context, examples of the driver assistance system 49 may include one or more subsystems such as a lane assist system, a speed assist system, a blind spot detection system, a park assist system, or an adaptive cruise control system and examples of the passenger comfort system 50 may include one or more subsystems such as automatic climate control, electronic seat adjustment, automatic wipers, automatic headlamps, and automatic cooling. Aspects of the navigation system 42, the entertainment system 44, the audio system 46, and the communications system 48 may be combined into an infotainment system. In addition, it is to be understood there may be overlap between different vehicle control systems and the presence or absence of certain vehicle control systems depending upon the type of vehicle, the type of fuel or propulsion system, the size of the vehicle, and other factors and variables.

In one embodiment, the wireless earpieces 12 include a left wireless earpiece 12A and a right wireless earpiece 12B and are in operative communication with the vehicle control system 40 via the communications system 48. The communications system 48 may include one or more wireless transceivers, such as Bluetooth, Wi-Fi, or cellular transceivers. The communications system 48 may communicate with the wireless earpieces 12 directly or through a mobile device 4, such as a mobile phone, a tablet, or other type of mobile device. For example, the communications system 48 may provide a Bluetooth or BLE link directly to the wearable devices or may provide a Bluetooth or BLE link to a mobile phone in operative communication with either the left wireless earpieces 12A or the right wireless earpiece 12B.

As will be explained in further detail with respect to various examples, the wireless earpieces 12 may interact with the smart windshield 3 in any number of different ways. For example, the wireless earpieces 12 may provide sensor data (e.g., biometrics, user input, environmental data, etc.), identity information, stored information, streamed information, or other types of information to the vehicle 2. Based on this information, the vehicle 2 may take any number of actions which may include one or more actions taken by the smart windshield 3 and vehicle control system 40 (or subsystems thereof). For example, user preferences, settings, permissions, or other configuration information may control how, when, and what data is displayed by the smart windshield 3. In addition, the vehicle 2 may communicate sensor data, vehicle performance information, safety information, identity information, system information, stored information, streamed information or other types of information to the wireless earpieces 12.

In one embodiment, the smart windshield 3 may represent any number of display systems. The smart windshield is a transparent display presenting data, information, or content (e.g., images, video, augmented reality content, etc.) without requiring users to look away from their usual viewpoints. In one example, the smart windshield 3 may represent a transparent organic light emitting diode. Transparent OLEDs use transparent or semi-transparent contacts on both sides of the smart windshield 3 to create a transparent display. The smart windshield 3 may incorporate elements of automatic safety glass as well as provide a heads-up-display.

The smart windshield 3 may also represent any number of heads-up-displays. For example, the smart windshield 3 may utilize optical waveguides to produce images directly in a combiner. The smart windshield 3 may also utilize a scanning laser to display images and imagery on a clear transparent medium. In some cases, the smart windshield 3 may include a projector unit, a combiner, and a video generation computer. The projection unit may be an optical collimator

The smart windshield 3 may also represent electronic glass or smart glass. The smart glass is glass or glazing whose transmission and display properties are altered when voltage, light, or heat is applied to display content, data or information. In one embodiment, the smart windshield 3 may be formed from suspended particle devices (SPDs). The SPDs may be a thin film laminate of rod-like nano-scale particles suspended in a liquid and placed between two pieces of glass or plastic or attached to one layer.

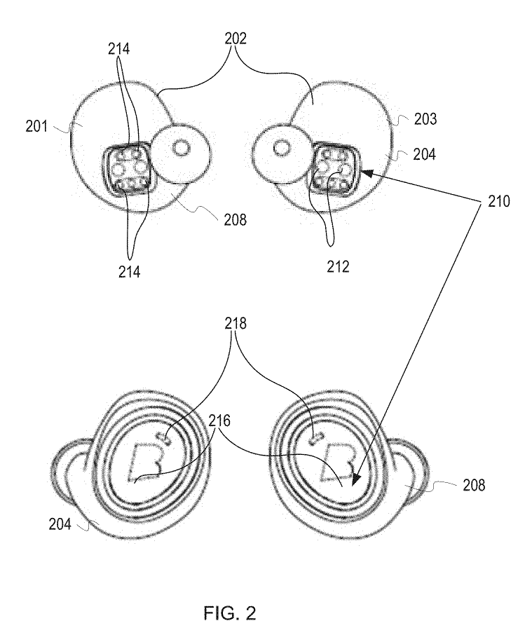

FIG. 2 is a pictorial representation of the wireless earpieces 202 in accordance with illustrative embodiments. As shown the wireless earpieces 202 may include a left wireless earpiece 201 and a right wireless earpiece 203 representative of a set of wireless earpieces. In other embodiments, a set of wireless earpieces may include several left wireless earpieces 201 and right wireless earpieces 203. The illustrative embodiments may also be applicable to large numbers of wireless earpieces 202 utilized in a vehicle (e.g., driver and passengers all using wireless earpieces).

In some applications, temporary adhesives or securing mechanisms (e.g., clamps, straps, lanyards, extenders, wires, etc.) may be utilized to ensure the wireless earpieces 202 remain in the ears of the user even during the most rigorous and physical activities or to ensure if they do fall out they are not lost or broken. For example, the wireless earpieces 202 may be utilized during marathons, swimming, team sports, biking, hiking, parachuting, or so forth. The wireless earpieces 202 may be utilized or shared during any number of sports, communications, recreational, business, military, training, or other activities or actions. In one embodiment, miniature straps may attach to the wireless earpieces 202 with a clip on the strap securing the wireless earpieces to the clothes, hair, or body of the user. The wireless earpieces 202 may be configured to play music or audio, receive and make phone calls or other communications, determine ambient environmental conditions (e.g., temperature, altitude, location, speed, heading, etc.), read user biometrics (e.g., heart rate, motion, temperature, sleep, blood oxygenation, voice output, calories burned, forces experienced, etc.), and receive user input, feedback, or instructions. The wireless earpieces 202 may also execute any number of applications to perform specific purposes. The wireless earpieces 202 may be utilized with any number of automatic assistants, such as Siri, Cortana, Alexa, Google, Watson, or other smart assistants/artificial intelligence systems.

In one embodiment, the wireless earpieces 202 includes a housing 204 shaped to fit substantially within the ears of the user. The housing 204 is a support structure at least partially enclosing and housing the electronic components of the wireless earpieces 202. The housing 204 may be composed of a single structure or multiple intercoupled structures.

The housing 204 defines an extension 208 configured to fit substantially within the ear of the user 106. The extension 208 may include one or more speakers or vibration components for interacting with the user 106. The extension 208 may be removably covered by one or more sleeves. The sleeves may be changed to fit the size and shape of the user's ears. The sleeves may come in various sizes and have extremely tight tolerances to fit the user 106 and one or more other users may utilize the wireless earpieces 202 during their expected lifecycle. In another embodiment, the sleeves may be custom built to support the interference fit utilized by the wireless earpieces 202 while also being comfortable while worn. The sleeves are shaped and configured to not cover various sensor devices of the wireless earpieces 202. Separate sleeves may be utilized if different users are wearing the wireless earpieces 202.

In one embodiment, the housing 204 or the extension 208 (or other portions of the wireless earpieces 202) may include sensors 210 for sensing pulse, blood oxygenation, temperature, voice characteristics, skin conduction, glucose levels, impacts, activity level, position, location, orientation, as well as any number of internal or external user biometrics. In other embodiments, the sensors 210 may be positioned to contact or be proximate the epithelium of the external auditory canal or auricular region of the user's ears when worn. For example, the sensors 210 may represent various metallic sensor contacts, optical interfaces, or even micro-delivery systems for receiving, measuring, and delivering information and signals. Small electrical charges or spectroscopy emissions (e.g., various light wavelengths) may be utilized by the sensors 210 to analyze the biometrics of the user including pulse, blood pressure, skin conductivity, blood analysis, sweat levels, and so forth.

As previously noted, the wireless earpieces 202 may include any number of internal or external sensors 210. In one embodiment, the sensors 210 may be utilized to determine environmental information and whether the wireless earpieces are being utilized by different users. Similarly, any number of other components or features of the wireless earpieces 202 may be managed based on the measurements made by the sensors 210 to preserve resources (e.g., battery life, processing power, etc.). The sensors 210 may make independent measurements or combined measurements utilizing the sensory functionality of each of the sensors 210 to measure, confirm, or verify sensor measurements. In one embodiment, the sensors 210 may include optical sensors 212, contact sensors 214, infrared sensors 216, and microphones 218.

In one embodiment, the sensors 210 may include optical sensors 212 emitting and measuring reflected light within the ears of the user to measure any number of biometrics. The optical sensors 212 may also be utilized as a second set of sensors to determine when the wireless earpieces 202 are in use, stored, charging, or otherwise positioned. The sensors 210 may be utilized to provide relevant information communicated through one or more transceivers.

The optical sensors 212 may generate an optical signal communicated to the ear (or other body part) of the user and reflected. The reflected optical signal may be analyzed to determine blood pressure, pulse rate, pulse oximetry, vibrations, blood chemistry and other information about the user. The optical sensors 212 may include any number of sources for outputting various wavelengths of electromagnetic radiation and visible light. Thus, the wireless earpieces 202 may utilize spectroscopy as it is known in the art and developing to determine any number of user biometrics.

The optical sensors 212 may also be configured to detect ambient light proximate the wireless earpieces 202. In one embodiment, the optical sensors 212 may also include an externally facing portion or components. For example, the optical sensors 212 may detect light and light changes in an environment of the wireless earpieces 202, such as in a room where the wireless earpieces 202 are located. The optical sensors 212 may be configured to detect any number of wavelengths including visible light relevant to light changes, approaching users or devices, and so forth.

In another embodiment, the contact sensors 214 may be utilized to determine the wireless earpieces 202 are positioned within the ears of the user. For example, conductivity of skin or tissue within the user's ear may be utilized to determine the wireless earpieces are being worn. In other embodiments, the contact sensors 214 may include pressure switches, toggles, or other mechanical detection components for determining the wireless earpieces 202 are being worn. The contact sensors 214 may measure or provide additional data points and analysis indicating the biometric information of the user. The contact sensors 214 may also be utilized to apply electrical, vibrational, motion, or other input, impulses, or signals to the skin or body of the user.

The wireless earpieces 202 may also include infrared sensors 216. The infrared sensors 216 may be utilized to detect touch, contact, gestures or another user input. The infrared sensors 216 may detect infrared wavelengths and signals. In another embodiment, the infrared sensors 216 may detect visible light or other wavelengths as well. The infrared sensors 216 may be configured to detect light or motion or changes in light or motion. Readings from the infrared sensors 216 and the optical sensors 212 may be configured to detect light or motion. The readings may be compared to verify or otherwise confirm light or motion. As a result, decisions regarding user input, biometric readings, environmental feedback, and other measurements may be effectively implemented in accordance with readings from the sensors 210 as well as other internal or external sensors and the user preferences. The infrared sensors 216 may also be integrated in the optical sensors 212. The infrared sensors 216 may detect contact with the wireless earpieces 202 as well as gestures performed adjacent the wireless earpieces 202.

Further, the infrared sensors 206 may include emitter and receivers detecting and measuring infrared light radiating from objects in their field of view. The infrared sensors 206 may detect gestures, touches, or other user input against an exterior portion of the wireless earpieces 202 visible when worn by the user. The infrared sensors 206 may also detect infrared light or motion. The infrared sensors 206 may be utilized to determine whether the wireless earpieces 202 are being worn, moved, approached by a user, set aside, stored in a smart case, placed in a dark environment, or so forth. The infrared sensors 206 may also include capacitive sensors detecting the touch and specific motion of the user's fingers, hands, or so forth.

The wireless earpieces 210 may include microphones 218. The microphones 218 may represent external microphones as well as internal microphones. The external microphones can be positioned exterior to the body of the user as worn. The external microphones may sense verbal or audio input, feedback, and commands received from the user. The external microphones may also sense environmental, activity, and external noises and sounds. The internal microphone may represent an ear-bone or bone conduction microphone. The internal microphone may sense vibrations, waves, or sound communicated through the bones and tissue of the user's body (e.g., skull). The microphones 218 may sense content utilized by the processor of the wireless earpieces 202 to implement the processes, functions, and methods herein described. The audio input sensed by the microphones 218 may be filtered, amplified, or otherwise processed before or after being sent to the logic of the wireless earpieces 202. In other embodiments, the wireless earpieces 202 may not have sensors 210 or may have very limited sensors.

In another embodiment, the wireless earpieces 202 may include chemical sensors (not shown) performing chemical analysis of the user's skin, excretions, blood, or any number of internal or external tissues or samples. For example, the chemical sensors may determine whether the wireless earpieces 202 are being worn by the user. The chemical sensor may also be utilized to monitor important biometrics effectively read utilizing chemical samples (e.g., sweat, blood, excretions, etc.). In one embodiment, the chemical sensors are non-invasive and may only perform chemical measurements and analysis based on the externally measured and detected factors. In other embodiments, one or more probes, vacuums, capillary action components, needles, or other micro-sampling components may be utilized. Minute amounts of blood or fluid may be analyzed to perform chemical analysis reported to the user and others. The sensors 210 may include parts or components periodically replaced or repaired to ensure accurate measurements. For example, the wireless earpieces 202 may include a sensor module replaced as needed.

In one embodiment, the sensors verify the identity of the user utilizing the measurements and biometrics determined by the sensors 210. For example, the wireless earpieces may verify the user can utilize the vehicle as well as the smart windshield of the vehicle. In some embodiments, an administrator, parent, guardian, manager, or other authorized party may indicate which information, features, and functions may be implemented through the wireless earpieces and/or smart windshield. For example, a parent may not allow a teen-driver to utilize the smart windshield to display phone call information, text messages, or music being played through the smart windshield even though those features may be allowed for the parent and other more experienced drivers.

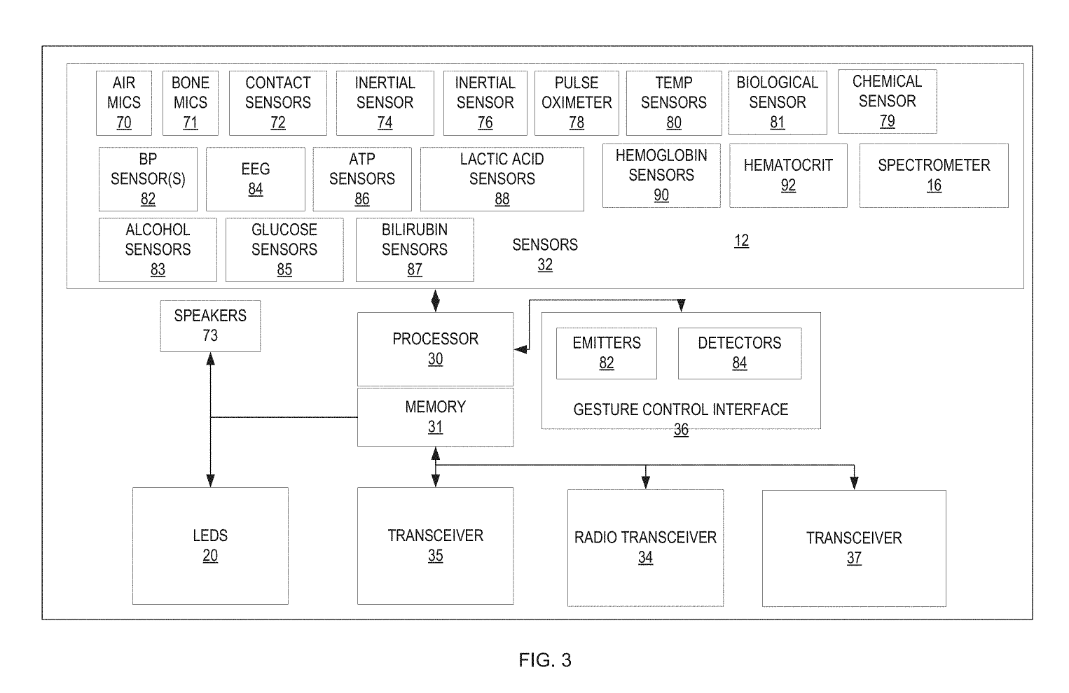

FIG. 3 is a block diagram illustrating a wireless earpiece 12, such as the left wireless earpiece 201 or the right wireless earpiece 203 of FIG. 2 in accordance with an illustrative embodiment. The wireless earpiece 12 may include one or more LEDs 20 electrically coupled to a processor 30. The processor 30 may include one or more processors, microcontrollers, application specific integrated circuits, or other types of integrated circuits. The processor 30 may also be electrically coupled to one or more sensors 32. The sensors may include inertial sensors 74, 76. Each inertial sensor 74, 76 may include an accelerometer, a gyroscope, gyro sensor, or gyrometer, a magnetometer, and/or other type of inertial sensors.

The sensors 32 may also include one or more of contact sensors 72, bone conduction microphones 71, air conduction microphones 70, chemical sensors 79, a pulse oximeter 76, one or more temperature sensors 80, and/or other physiological, environment, biometric, or biological sensors. Further examples of physiological or biological sensors include one or more of an alcohol sensor 83, a glucose sensor 85, or a bilirubin sensor 87. Other examples of physiological or biological sensors may also be included. These may include, but are not limited to, a blood pressure sensor 82, an electroencephalogram (EEG) 84, an Adenosine Triphosphate (ATP) sensor, a lactic acid sensor 88, a hemoglobin sensor 90, a hematocrit sensor 92 or other biological or chemical sensor. The wireless earpiece 12 may also include any number of other sensors, including, but not limited to, radiation sensors, altimeters, barometers, humidity sensors, impact sensors, skin conductivity, GPS, velocity sensors, and so forth.

A spectrometer 16 (optical sensor) utilized for measuring and recording spectra is also shown. The spectrometer 16 may measure optical signals, infrared (IR), ultraviolet (UV), and so forth although it is contemplated any number of wavelengths in the infrared, visible, or ultraviolet spectrums may be detected (even including radio, microwave, X-ray, and gamma ray). The spectrometer 16 may be adapted to measure and analyze environmental wavelengths for processing and recommendations and may correspondingly be located on or at the external facing side of the wireless earpiece 12.

A gesture control interface 36 is also operatively coupled to or integrated into the processor 30. The gesture control interface 36 may include one or more emitters 82 and one or more detectors 84 for sensing user gestures. The emitters 82 may be of any number of types or utilize any number of signals, standards, or protocols including infrared LEDs. The detectors 84 may detect reflected light or signals to determine a gesture performed by a user of the wireless earpiece 12.

The wireless earpiece 12 may include any number of transceivers 34, 35, 37. The transceivers 34, 35, 37 are components including both a transmitter and receiver which may be combined and share common circuitry, chip, on a single housing. The wireless earpiece 12 may include a transceiver 35 which may allow for induction transmissions, such as through near field magnetic induction. A transceiver 34 may use Bluetooth, Wi-Fi, 3G, 4G, 5G, PCS, WiMAX, BLE, UWB, or other radio communication signals, protocols, formats, or standards. In operation, the processor 30 may be configured to convey different information using one or more of the LEDs 20 based on context or mode of operation of the device. The LEDs 20 are semiconductor based light sources. The LEDs 20 may also include displays, touch sensors, or other interface components. The LEDs 20 may be configured to provide information concerning the wireless earpieces 12. For example, the processor 30 may communicate a signal encoding information related to the current time, the battery life of the earpiece, the status of another operation of the earpiece, or another earpiece function, wherein the signal is decoded and displayed by the LEDs 20. Utilization information associated with the wireless earpiece 12 may also be communicated utilizing the LEDs. In one embodiment, the LEDs 20 may include one or more miniature screens or displays integrated into the wireless earpiece 12.

The various sensors 32, the processor 30, and other electronic components may be located on the printed circuit board of the wireless earpiece 12. One or more speakers 73 may also be operatively coupled to the processor 30. Although not shown, the one or more speakers 73 of the wireless earpieces 12 may include several speaker components (e.g., signal generators, amplifiers, drivers, and other circuitry) configured to generate sound waves at distinct frequency ranges (e.g., bass, woofer, tweeter, midrange, etc.) or to vibrate at specified frequencies to be perceived by the user as sound waves. The speakers 73 may also generate sound waves to provide three-dimensional stereo sound to the user.

A transceiver 37 may represent a magnetic induction electric conduction electromagnetic (E/M) field transceiver or other type of electromagnetic field receiver may also be operatively coupled to the processor 30 to link the processor 30 to the electromagnetic field of the user. The use of the E/M transceiver 37 allows the device to link electromagnetically into a personal area network, body area network or other device.

One or more processors within the processor 30 may be disposed, mounted, or integrated within the earpiece housings and operatively coupled to the components of the respective wireless earpieces 12. In one embodiment, the processor includes circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks.

The processor may be configured to process information received from the various components. The processors may execute any number of operating systems, kernels, applications, or instructions. For example, processors may execute a program stored in a memory 31 related to explaining the fit, configuration, and utilization of the wireless earpieces 12. For example, the information may be provided to the user utilizing the LEDs 20 or the speakers 73.

The memory 31 is one or more hardware elements, devices, or recording media configured to store data for subsequent retrieval or access later. The memory 31 may be or include static and/or dynamic memory. The memory 31 may include one or more of a hard disk, random access memory, cache, removable media drive, mass storage, or configuration suitable as storage for data, instructions, and information. In one embodiment, the memory 31 and the processor 30 may be integrated. The memory 31 may use any type of volatile or non-volatile storage techniques and mediums. The memory 31 may store information related to the status of a user, wireless earpieces 12, and other peripherals, such as a wireless device, smart case for the wireless earpieces 12, smart watch, and so forth. In one embodiment, the memory 31 may display instructions or programs for controlling a user interface which may include the one or more LEDs 20, speakers 73, tactile generators (e.g., vibrator), and so forth. The memory 31 may also store the user input information associated with each command. The memory 31 may store user preferences including parameters, settings, factors, user information, and so forth utilized to implement automatic or manual processes as are herein described.

Although several different components are shown in FIG. 3, it is to be understood the wireless earpiece 12 need not include all the various components and may only include a subset of the components. For example, in one embodiment the wireless earpieces 12 may only serve as a set of wireless earpieces without microphones, without physiological sensors, and need not include storage. It is to be further understood where there is a set of wireless earpieces some of the components may be present only in one of the wireless earpieces within the set. For example, not all sensors 32 need be present in each wireless earpiece 12.

The wireless earpieces 12 may be integrated as part of one or more vehicle networks. Examples of vehicle networks may utilize any number of networks, standards, or protocols. For example, the protocols may include a Controller Area Network (CAN), Local Interconnect Network (LIN), or others including proprietary network protocols or network protocol overlays. The wireless earpieces 12 may communicate with any number of different types of electronic control modules through the vehicle network including the smart windshield. These may include electronic control modules such as an engine control unit (ECU), a transmission control unit (TCU), an anti-lock braking system (ABS), a body control module (BCM), a door control unit (DCU), an electric power steering control unit (PSCU), a human-machine interface (HMI), a powertrain control module (PCM), a speed control unit (SCU), a telematic control unit (TCU), a brake control unit (BCM), a battery management system, or other control modules not listed. Any number of electronic control modules may be operatively coupled to the vehicle network.

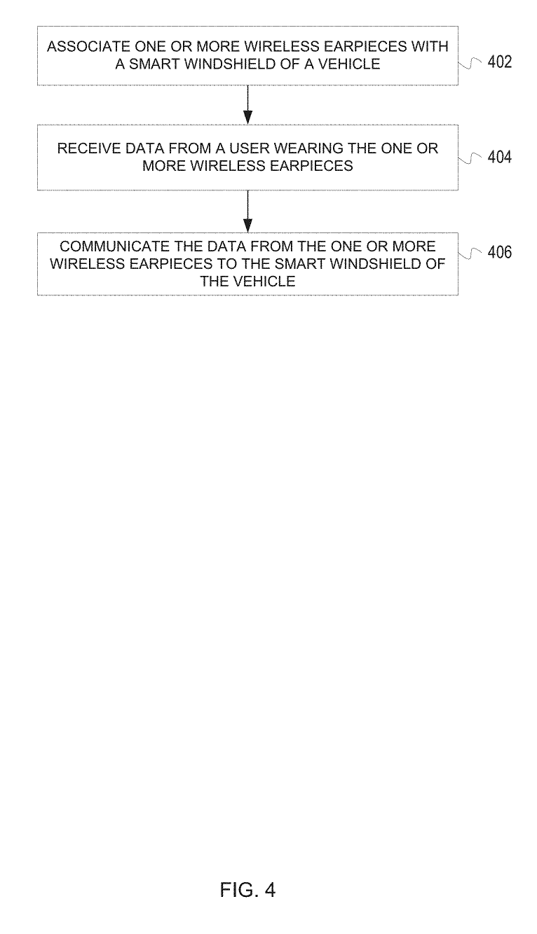

FIG. 4 is a flowchart of a process for communications between one or more wireless earpieces and a smart windshield of a vehicle in accordance with an illustrative embodiment. In one embodiment, the process of FIG. 4 may be implemented by a set of wireless earpieces (e.g., a left wireless earpiece and a right wireless earpiece) utilized by a user or one or more wireless earpieces utilized by different users (e.g., drivers and a passenger). As described herein, communications or processes performed by the smart windshield may also be implemented partially by the associated vehicle systems as described and shown herein.

In one embodiment, the process may begin by associating one or more wireless earpieces with a smart windshield of a vehicle (step 402). The associating may represent the one or more wireless earpieces being linked for communication with the smart windshield. For example, the devices may be linked utilizing a Bluetooth pairing process. The linking may also represent a linking between the vehicle communication systems with the one or more wireless earpieces. In other examples, any number of short range communications including radio frequency or optical signals may be utilized between the wireless earpieces and the smart windshield. In one embodiment, a password or pin number may be required to associate the one or more wireless earpieces with the smart windshield.

Next, the one or more wireless earpieces receive data from a user wearing the one or more wireless earpieces (step 404). The data may represent any number of different types of information, data, or other measurements relating to the user, user's environment, the vehicle, passengers, or so forth. In one embodiment, the data may represent biometrics measured by the sensors of the one or more wireless earpieces, such as heart rate, temperature, blood pressure, head position, head orientation, impact levels, electrocardiogram, sweat levels, blood oxygenation, blood chemistry, or so forth. The data may provide information related to the status, condition, safety, or other information of the user. The data may also represent a temperature, humidity, noise level, speed, or other information related to the ambient, environment, cabin, or other space associated with the vehicle. The data may also represent user input or feedback received from the user(s) wearing the one or more earpieces. For example, the user may provide a verbal, tactile, gesture, or movement-based input and commands through the one or more wireless earpieces.

Next, the one or more wireless earpieces communicate the data from the one or more wireless earpieces to the smart windshield of the vehicle (step 406). In one embodiment, the data may be formatted for communication between the one or more wireless earpieces and the smart windshield. For example, the data may be packetized, encrypted, processed, or otherwise formatted for the signal, link, or connection utilized between the one or more wireless earpieces and the smart windshield. In another example, the data is communicated as a command to be implemented by the smart windshield. In one embodiment, before the process of FIG. 4 is implemented the wireless earpieces may verify the one or more wireless earpieces are authorized to communicate with the smart windshield as well as what, if any, data, may be communicated to or received from the smart windshield.

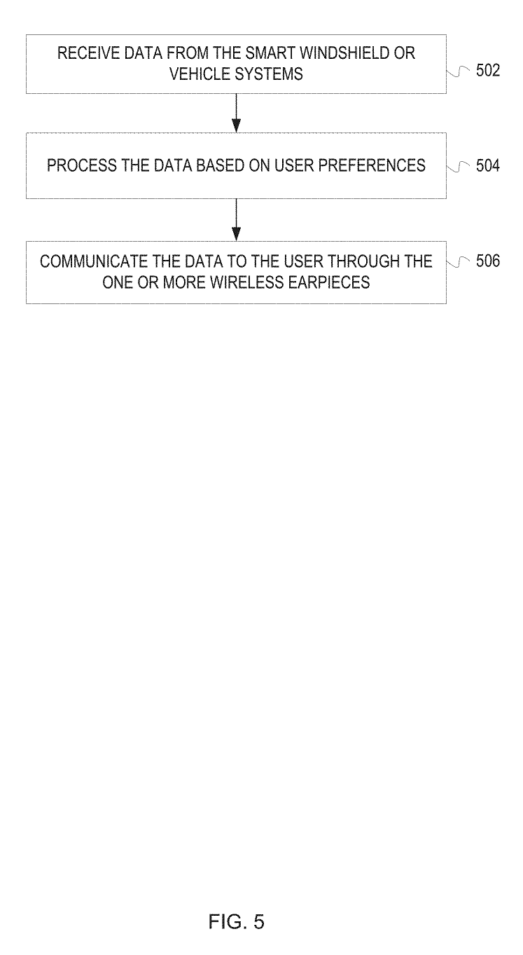

FIG. 5 is a flowchart of a process for communications between one or more wireless earpieces and a smart windshield in accordance with an illustrative embodiment. The process of FIG. 5 may be implemented or integrated with the steps or process of FIG. 4. The process may begin by receiving data from the smart windshield or vehicle systems (step 502). The communications between the smart windshield and the one or more wireless earpieces may be performed through the established link, connection or signal.

Next, the one or more wireless earpieces process the data based on user preferences (step 504). The user preferences may include any number of settings, configurations, parameters, permissions, application settings, or so forth. During step 504, the data may be processed to determine how the data is played, presented, or otherwise communicated to the user(s) wearing the one or more wireless earpieces.

Next, the one or more wireless earpieces communicate the data to the user through the one or more wireless earpieces (step 506). The data may be communicated utilizing any number of processes, components, or communications methods available to the wireless earpieces. For example, the data may be communicated audibly to the user utilizing words, numbers, or other sound or audio input. The data may also be communicated utilizing any number of tactile input's, such as vibrations, pulses, electrical signals, or so forth. The data may also be communicated utilizing one or more light emitting diodes, displays, or other interfaces of the wireless earpieces or associated peripherals (e.g., smart case, connectors, cords, etc.).

In one embodiment, in a parked, auto-drive, or stationary mode, the smart windshield may display video, documents, messages, or other content tactilely or audibly presented to the user through the one or more wireless earpieces. The user may utilize voice-to-text translation and commands to communicate, interact, and edit content as the law, circumstances, and administrative permissions allow.

According to another aspect, information from the wireless earpieces may be used to improve the comfort and/or safety of a driver or passenger by suggesting user settings for optimum comfort, optimum safety, or both. The wireless earpieces may utilize physiological sensors and physiological data or biometric data available to suggest specific user settings through the smart windshield. For example, recommendations for seat settings based on the height of the user or the measurements of the individual's legs, torso, arm length, or other relevant parts of the user's body may be communicated by the smart windshield based on a user profile or other information stored in the wireless earpieces.

In another example, when an individual wearing associated wireless earpieces enters a vehicle the first time, such as when selecting a vehicle to buy. Based on available biometric information from the wireless earpieces, the vehicle may self-adjust to settings consistent with the known biometric information to increase the comfort of the individual, better accommodate the individual, and provide an enhanced initial experience with the vehicle. Similarly, if an individual prefers other settings than those recommended, information about those settings may be communicated to the wireless earpieces and communicated to other vehicles or other devices which the driver may operate.

It is generally accepted as dangerous for individuals operating a vehicle to wear head phones, ear buds, or other such devices which prevent individuals from being able to hear ambient sounds when operating vehicles. In addition, operating vehicles while wearing headphones or ear buds is generally prohibited by law. In one embodiment, the wireless earpieces are configured to capture and reproduce ambient sounds audible to the driver. This may be accomplished by using one or more microphones on the earpieces to detect ambient sound and subsequently reproducing the ambient sound at one or more speakers of the earpieces. Thus, even though the operator is wearing earpieces there is audio transparency.

Where the driver is wearing earpieces, the wireless earpieces may lock themselves in a mode which provides for ambient noise pass-through. Thus, even though the driver is wearing wireless earpieces the driver can hear ambient sound. In addition, the wireless earpiece may provide for further processing to enhance ambient sounds to assist the driver in operating the vehicle. This enhancement may be performed in various ways including increasing the volume or amplitude of the ambient sounds.

The illustrative embodiments may take the form of an entirely hardware embodiment, an entirely software embodiment (including firmware, resident software, micro-code, etc.) or an embodiment combining software and hardware aspects all generally referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, including a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or another communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely or partially on a user's wireless device, wireless earpieces, smart windshield, vehicle systems, or computer, as a stand-alone software package, partly on the user's device(s) and partly on a remote computer or entirely on the remote computer or server. In the latter scenario, the remote computer may be coupled to the user's computer through any type of network, including a local area network (LAN), a personal area network (PAN), or a wide area network (WAN), or the connection may be made to an external computer (e.g., through the Internet using an Internet Service Provider).

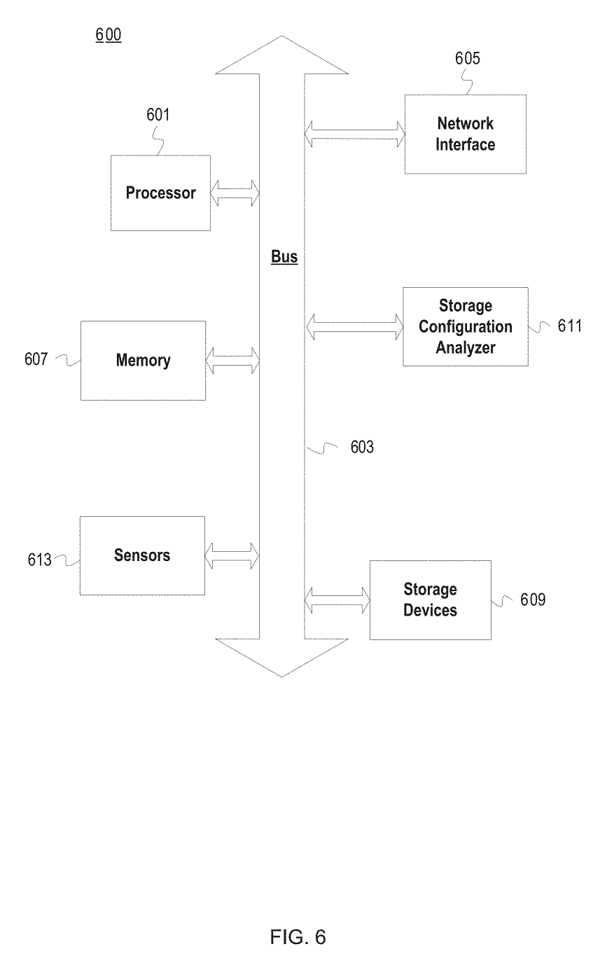

FIG. 6 depicts a computing system 600 in accordance with an illustrative embodiment. For example, the computing system 600 may represent a device, such as a vehicle system, or wireless device of FIG. 1. The computing system 600 includes a processor unit 601 (possibly including multiple processors, multiple cores, multiple nodes, and/or implementing multi-threading, etc.). The computing system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 603 (e.g., PCI, ISA, PCI-Express, HyperTransport®, InfiniBand®, NuBus, etc.), a network interface 606 (e.g., an ATM interface, an Ethernet interface, a Housing Relay interface, SONET interface, wireless interface, etc.), and a storage device(s) 609 (e.g., optical storage, magnetic storage, etc.).

The system memory 607 embodies functionality to implement all or portions of the embodiments described above. The system memory 607 may include one or more applications or sets of instructions for implementing communications between a vehicle and one or more wireless earpieces. In one embodiment, specialized sharing software may be stored in the system memory 607 and executed by the processor unit 601. As noted, the communication application or software may be similar or distinct from the application or software utilized by the wireless earpieces. Code may be implemented in any of the other devices of the computing system 600. Any one of these functionalities may be partially (or entirely) implemented in hardware and/or on the processing unit 601. For example, the functionality may be implemented with an application specific integrated circuit, in logic implemented in the processing unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601, the storage device(s) 609, and the network interface 605 are coupled to the bus 603. Although illustrated as being coupled to the bus 603, the memory 607 may be coupled to the processor unit 601. The computing system 600 may further include any number of sensors 613, such as optical sensors, accelerometers, magnetometers, microphones, gyroscopes, temperature sensors, and so forth for verifying user biometrics, or environmental conditions, such as motion, light, or other events may be associated with the wireless earpieces or their environment.

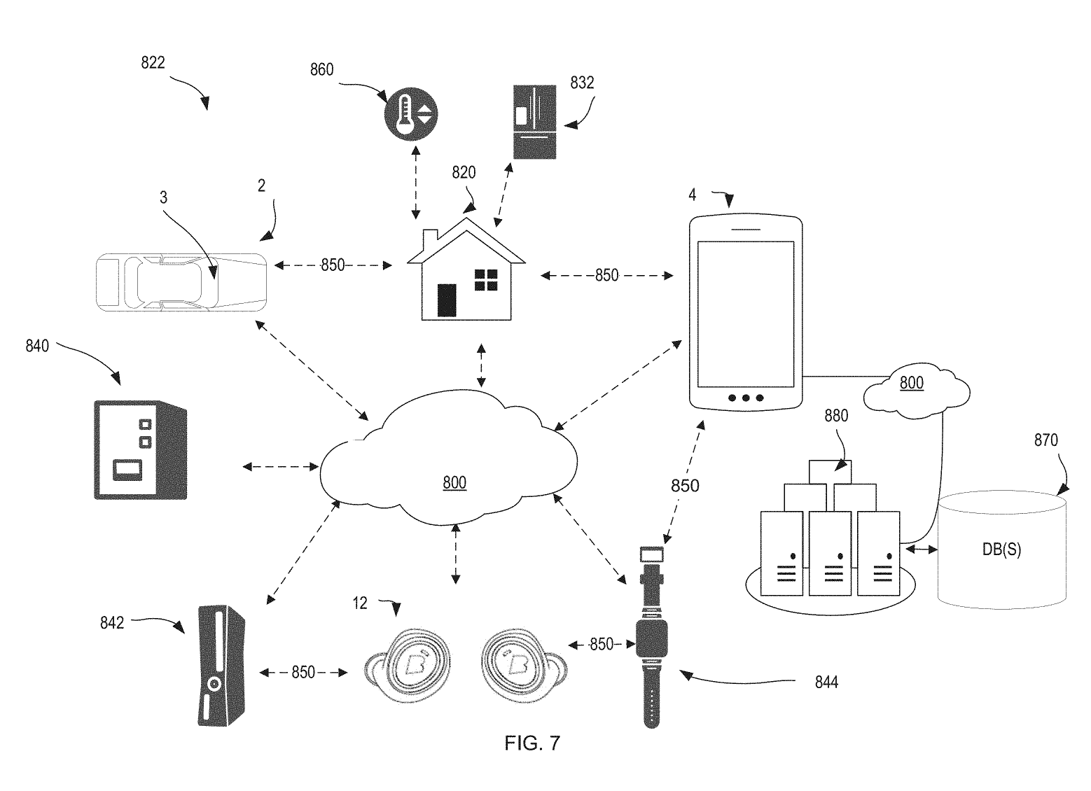

With reference to FIG. 7 embedded devices within an IoT network in an illustrative embodiment is shown. CIERTED (constrained intelligent edge real time embedded device), wireless earpieces 12, are shown with other CIERTED in IoT network 822. IoT network 822 is the network of CIERTED, such as, vehicles 2, home appliances 832 and other items embedded with electronics, software, sensors, actuators and network connectivity which enables these objects to connect and exchange data. Each CIERTED is uniquely identifiable through its embedded computing system but can inter-operate within the existing Internet infrastructure 800. The IoT network 822 allows objects to be sensed or controlled remotely across existing network infrastructure 800, creating opportunities for more direct integration of the physical world into computer-based systems, and resulting in improved efficiency, accuracy and economic benefit in addition to reduced human intervention.

CIERTED in the IoT network 822, can refer to a wide variety of devices such as wireless earpieces 12, vending machine 840, gaming system 842, smart watch 844, automobiles 2 with smart windshield 3, smart home 820 with smart HVAC 860 or refrigerator 832 or mobile device 4. These CIERTED collect useful data with the help of various existing technologies and then autonomously flow the data between other devices. These items are but a small list of the possible CIERTED discussed in detail above. While only a handful of CIERTED have been shown in the present application, it is fully contemplated most any electronic device having processing capabilities could be a CIERTED without departing from the spirit of the invention.

CIERTED can identify and couple with any identifiable CIERTED, either locally through direct communications 850 or through an internet network 800. Once CIERTED are paired with other CIERTED, they can interact, control functionality and/or communicate with these CIERTED. Furthermore, wireless earpieces 12 can be used to control other CIERTED through the IoT network 822.

A user could send voice instructions through the wireless earpieces 12 to smart home 820 to have HVAC system 860 turn the temperature up or down in smart home 820. Smart home 820 can then interrogate refrigerator 832 to determine if any grocery shopping needed to be done. Smart home 820 would then send a message (either via SMS, text or voice) back to the wireless earpieces 12 informing the user the task was complete and providing a grocery list to the user they can use at the supermarket. This application could also be performed with a smart assistant (e.g., Alexa®, Siri®, Google Home® and Cortana®) which speaks directly to the wireless earpieces 12 and allows the user to speak directly through a speaker coupled to the smart assistant to directly speak to the smart home 820 or to instruct the smart assistant to directly control the smart home 820.

A user can purchase a snack treat out of vending machine 840 through voice commands to wireless earpieces 12. The user can instruct what snack they would like, such as “A7” or “Nutter-Butter Bar”. When prompted by vending machine 840, wireless earpieces 802 could provide credit/debit information stored within memory 31 to vending machine 840. Vending machine 840 would then provide the “Nutter-Butter Bar” to the user upon successful processing of the user's billing information.

A user could also instruct their gaming system 842 to begin downloading a game the user discovered while away from home. The user could use a voice command to the wireless earpieces 802 to give the instructions over network 800 of IoT network 822 and gaming system 842 could begin the ordering and downloading of a game.

A user could also send a text via smart watch 844. A user could give an initial instruction to communicate with the smart watch 844, saying “Smart Watch” and then begin giving instructions to dictate and send a text. Or perhaps the user would like to know their biometric readings during their last workout or to have their biometric readings from their last workout stored on database 870 for storage and analysis. The user would simply instruct smart watch 844 through voice or any other type of command through wireless earpiece 802 to have the smart watch 844 perform these functions.

A user could also ask vehicle 2 what the mileage is on vehicle 2 and if vehicle 2 needs servicing. The user could also request smart windshield 3 obtain and display directions for the user's next trip before the user gets to the vehicle. Further, all the events discussed above could be displayed on smart windshield 3 such as, a grocery list, temperature setting in smart home 820, a text from smart watch 844, ordering instructions and confirmation from gaming system 842 as well as vehicle mileage. All through network 800 of IoT network 822 controlled by wireless earpieces 12.

The wireless earpieces 12 may also utilize edge computing to make operation efficient and seamless. Edge computing is a method of optimizing cloud-computing systems by performing data processing at the edge of the network, near the source of the data. For purposes of the present invention, each CIERTED, mobile device 4, vehicle 2, smart windshield 3, smart home 820, smart watch 844, gaming system 842 and vending machine 840 all could have the computing system 600 discussed thoroughly above. Because each CIERTED has a computing system 600, data processing can be performed at each device, thus reducing the communications bandwidth needed between the peripheral devices and the central data center 880 by performing analytics and knowledge generation at or near the source of the data; the CIERTED.

Edge computing pushes applications, data and computing power (services) away from centralized points 880 to the logical extremes of a network 822. Edge computing replicates fragments of information across distributed networks 822 of CIERTED, which may spread over a vast area. As a technological paradigm, edge computing is also referred to as mesh computing, peer-to-peer computing, autonomic (self-healing) computing, grid computing and by other names implying non-centralized, node-less availability.

Various methods, system, and apparatus have been shown and described relating to vehicles with wearable integration or communication. The illustrative embodiments are not to be limited to these specific examples but contemplate any number of related methods, systems, and apparatus and these examples may vary based on the specific type of vehicle, the specific type of wearable device, the various types of biometric data, the alert conditions where present, and the actions taken in response to health data and other considerations.

The features, steps, and components of the illustrative embodiments may be combined in any number of ways and are not limited specifically to those described. The illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated other alternatives or exemplary aspects are considered included in the disclosure. The description is merely examples of embodiments, processes or methods of the invention. It is understood any other modifications, substitutions, and/or additions may be made, which are within the intended spirit and scope of the disclosure. For the foregoing, it can be seen the disclosure accomplishes at least all the intended objectives.

The previous detailed description is of a small number of embodiments for implementing the invention and is not intended to be limiting in scope. The following claims set forth a few the embodiments of the invention disclosed with greater particularity.

What is claimed is:

1. A method for utilizing a smart windshield with one or more wireless earpieces, comprising:
associating the one or more wireless earpieces with the smart windshield;
receiving data from a user wearing the one or more wireless earpieces; and
communicating the data from the one or more wireless earpieces to the smart windshield of the vehicle.

2. The method of claim 1, wherein the one or more wireless earpieces are a pair of wireless earpieces.

3. The method of claim 1, further comprising:
verifying the user is authorized to utilize the smart windshield.

4. The method of claim 1, further comprising:
measuring biometrics of the user utilizing the one or more wireless earpieces.

5. The method of claim 4, wherein the verifying is performed utilizing biometrics measured by the one or more wireless earpieces.

6. The method of claim 4, wherein the data includes at least the biometrics measured by the one or more wireless earpieces.

7. The method of claim 1, further comprising:
controlling vehicle systems associated with the smart windshield utilizing user input in the data.

8. The method of claim 7, wherein the user input includes one or more of voice input, gesture controls, and tactile input.

9. The method of claim 1, further comprising:
adjusting volume controls of the vehicle in response to the data.

10. The method of claim 7, wherein the vehicle systems include at least two or more of navigation, climate control, entertainment, audio, communications, performance controls, passenger comfort, and driver assistance.

11. A wireless earpiece, comprising:
a housing for fitting in an ear of a user;
a processor controlling functionality of the wireless earpiece;
a plurality of sensors performing sensor measurements of the user and an environment of the user;
one or more transceivers managing communications between the wireless earpiece and a smart windshield;
wherein the processor associates the one or more wireless earpieces with the smart windshield, receives data from a user wearing the one or more wireless earpieces, and communicates the data from the one or more wireless earpieces to the smart windshield of the vehicle.

12. The wireless earpiece of claim 11, wherein the processor further verifies the user is authorized to utilize the smart windshield before communicating the data.

13. The wireless earpiece of claim 11, wherein the one or more transceivers communicate with vehicle systems coupled to the smart windshield to perform the communications.

14. The wireless earpiece of claim 11, wherein the data includes biometrics determined from the sensor measurements.

15. The wireless earpiece of claim 11, wherein the processor further controls vehicle systems associated with the smart windshield utilizing user input in the data.

16. The wireless earpiece of claim 15, wherein the user input includes one or more of voice input, gesture controls, and tactile input.

17. A smart windshield system, comprising:
a smart windshield operably capable of displaying data to a user;
an Internet of Things (IoT) network operably coupled to the smart windshield and a constrained intelligent edge real time embedded device (CIERTED); and
a wireless earpiece operably coupled to the IoT and the smart windshield, wherein the wireless earpiece can control the CIERTED and the data displayed on the smart windshield.

18. The system of claim 17, wherein the wireless earpiece, comprises:
a processor;
a memory operably coupled to the processor, wherein the memory associates the wireless earpiece with the smart windshield, receive data from the user wearing the wireless earpiece, and communicate the data from the wireless earpiece to the smart windshield of the vehicle.

19. The system of claim 18, wherein the wireless earpiece controls vehicle systems associated with the smart windshield utilizing user input.

20. The system of claim 19, wherein the user input includes one or more of voice input, gesture controls, and tactile input.
